(19) United States
(12) Patent Application Publication
(10) Pub. No.: US 2022/0207259 A1
(43) Pub. Date: Jun. 30, 2022

(54) OBJECT DETECTION METHOD AND APPARATUS, AND ELECTRONIC DEVICE

(71) Applicant: SENSETIME INTERNATIONAL PTE. LTD., Singapore (SG)

(72) Inventors: Xuesen ZHANG, Singapore (SG); Chunya LIU, Singapore (SG); Bairun WANG, Singapore (SG); Jinghuan CHEN, Singapore (SG)

(21) Appl. No.: 17/344,073

(22) Filed: Jun. 10, 2021

Related U.S. Application Data
(63) Continuation of application No. PCT/IB2021/053446, filed on Apr. 27, 2021.

(30) Foreign Application Priority Data
Dec. 29, 2020 (SG) 10202013165P

(51) Int. Cl. G06K 9/00; G06K 9/62; G06T 7/70; G06N 3/08

(52) U.S. Cl. CPC G06K 9/00228; G06K 9/00362; G06K 9/6202; G06T 7/70; G06K 9/6256; G06K 2209/21; G06N 3/08; G06T 2207/30201; G06T 2207/20084; G06T 2207/20081; G06K 9/6262

(57) ABSTRACT

Methods, apparatuses, systems, devices and computer-readable storage media for object detection are provided. In one aspect, a method includes: detecting one or more face objects and one or more body objects from an image to be processed, determining a matching relationship between a face object of the one or more face objects and a body object of the one or more body objects, and in response to determining that the body object matches the face object based on the matching relationship, determining the body object as a detected target object.

### CROSS-REFERENCE TO RELATED APPLICATIONS

The present disclosure is a continuation application of International Application No. PCT/IB2021/053446 filed on Apr. 27, 2021, which claims a priority of the Singaporean patent application No. 10202013165P filed on Dec. 29, 2020, all of which are incorporated herein by reference in their entireties.

### TECHNICAL FIELD

The present disclosure relates to the field of machine learning technology, and in particular, to an object detection method and apparatus, and an electronic device.

### BACKGROUND

Target detection is an important part of intelligent video analysis. For example, humans, animals and the like in video frames or scene images may be used as detection targets. In the related art, a target detector such as a Faster RCNN (Region Convolutional Neural Network) may be used to acquire target detection boxes from the video frames or scene images.

However, in dense scenes, different targets may occlude each other. Take a scene with relatively dense crowds of people as an example, human body parts such as arms, hands and legs may be occluded between different people. In this case, use of the conventional detector may cause false detection of the human body. For example, there are only two people in a scene image originally, but three human body boxes are detected from the scene image, this situation is usually called “false positive”. Inaccurate target detection may lead to errors in subsequent processing based on the detected targets.

### SUMMARY

In view of this, the present disclosure provides at least an object detection method and apparatus, and an electronic device, so as to improve the accuracy of target detection in dense scenes.

In a first aspect, there is provided an object detection method, including: detecting a face object and a body object from an image to be processed; determining a matching relationship between the detected face object and body object; and in response to determining that the body object matches the face object based on the matching relationship, determining the body object as a target object detected.

In some embodiments, detecting the face object and the body object from the image to be processed includes: performing object detection on the image to obtain detection boxes for the face object and the body object from the image.

In some embodiments, the method further includes: removing the detection box for the body object, in response to determining that there is no face object in the image matching the body object based on the matching relationship.

In some embodiments, the method further includes: determining the body object as the detected target object, in response to determining that there is no face object in the image matching the body object based on the matching relationship, and the body object being located in a preset edge area of the image.

In some embodiments, determining the matching relationship between the detected face object and body object includes: determining position information and/or visual information of the face object and the body object according to detection results for the face object and the body object; and determining the matching relationship between the face object and the body object according to the position information and/or the visual information.

In some embodiments, the position information includes position information of the detection boxes; and determining the matching relationship between the face object and the body object according to the position information and/or the visual information includes: for each face object, determining the detection box for the body object that satisfies a preset position overlapping relationship with the detection box for the face object as a target detection box, according to the position information of the detection boxes; and determining the body object in the target detection box as the body object that matches the face object.

In some embodiments, determining the matching relationship between the detected face object and body object includes: determining the matching relationship between the detected face object and body object, in response to the detected face object being not occluded by the detected body object and other face objects.

In some embodiments, the detected face object includes at least one face object and the detected body object includes at least one body object, and determining the matching relationship between the detected face object and body object includes: combining each of the detected face object with each of the detected body object to obtain at least one face-and-body combination, and determine the matching relationship for each of the combination.

In some embodiments, detecting the face object and the body object from the image to be processed includes: performing object detection on the image using an object detection network to obtain detection boxes for the face object and the body object from the image; and determining the matching relationship between the detected face object and body object includes: determining the matching relationship between the detected face object and body object using a matching detection network; and where, the object detection network and the matching detection network are trained by: detecting at least one face box and at least one body box from a sample image through the object detection network to be trained; acquiring a predicted value of a pairwise matching relationship between the detected face box and body box through the matching detection network to be trained; and adjusting a network parameter of at least one of the object detection network and the matching detection network, based on a difference between the predicted value and a label value of the matching relationship.

In a second aspect, there is provided an object detection apparatus, including: a detection processing module, configured to detect a face object and a body object from an image to be processed; a matching processing module, configured to determine a matching relationship between the detected face object and body object; and a target object determination module, configured to, in response to determining that the body object matches the face object based on the matching relationship, determining the body object as a target object detected.

In some embodiments, the detection processing module is further configured to perform object detection on the image to obtain detection boxes for the face object and the body object from the image.

In some embodiments, the target object determination module is further configured to remove the detection box for the body object, in response to determining that there is no face object in the image matching the body object based on the matching relationship.

In some embodiments, the target object determination module is further configured to determine the body object as the detected target object, in response to determining that there is no face object in the image matching the body object based on the matching relationship, and the body object being located in a preset edge area of the image.

In some embodiments, the matching processing module is further configured to: determine position information and/or visual information of the face object and the body object according to detection results for the face object and the body object; and determine the matching relationship between the face object and the body object according to the position information and/or the visual information.

In some embodiments, the position information includes position information of the detection boxes; and the matching processing module is further configured to: for each face object, determine the detection box for the body object that satisfies a preset position overlapping relationship with the detection box for the face object as a target detection box, according to the position information of the detection boxes; and determine the body object in the target detection box as the body object that matches the face object.

In some embodiments, the matching processing module is further configured to determine the matching relationship between the detected face object and body object, in response to the detected face object being not occluded by the detected body object and other face objects.

In some embodiments, the detected face object includes at least one face object and the detected body object includes at least one body object; and the matching processing module is further configured to combine each of the detected face object with each of the detected body object to obtain at least one face-and-body combination, and determine the matching relationship for each of the combination.

In some embodiments, the detection processing module is further configured to perform object detection on the image using an object detection network to obtain detection boxes for the face object and the body object from the image; and the matching processing module is further configured to determine the matching relationship between the detected face object and body object using a matching detection network; and where, the apparatus further includes a network training module configured to: detect at least one face box and at least one body box from a sample image through the object detection network to be trained; acquire a predicted value of a pairwise matching relationship between the detected face box and body box through the matching detection network to be trained; and adjust a network parameter of at least one of the object detection network and the matching detection network, based on a difference between the predicted value and a label value of the matching relationship.

In a third aspect, there is provided an electronic device including a memory and a processor, the memory is configured to store computer instructions executable on the processor, and the processor is configured to perform the method of any of the embodiments of the present disclosure when executing the computer instructions.

In a fourth aspect, there is provided a computer-readable storage medium in which a computer program is stored, the computer program, when executed by a processor, causes the processor to perform the method of any of the embodiments of the present disclosure.

In a fifth aspect, there is provided a computer program, including computer-readable codes which, when executed in an electronic device, cause a processor in the electronic device to perform the method of any of the embodiments of the present disclosure.

The object detection method and apparatus, and electronic device according to the embodiments of the present disclosure assist in the detection of the body object by using the detection of the matching relationship between the body object and the face object, and use the body object that has a matching face object as the detected target object. On one hand, since the detection accuracy of the face object is relatively high, the detection accuracy of the body object can also be improved by using the face object to assist in the detection of the body object; on the other hand, the face object belongs to the body object, thus the detection of the face object can assist in positioning the body object. This solution can reduce the occurrence of “false positive” or false detection, improving the detection accuracy of the body object.

### BRIEF DESCRIPTION OF DRAWINGS

In order to illustrate the technical solutions in one or more embodiments of the present disclosure more clearly, the accompanying drawings used in the embodiments will be briefly introduced below. Obviously, the drawings in the following description merely illustrate some embodiments of one or more embodiments of the present disclosure. For those ordinary skilled in the art, other drawings may also be obtained from these drawings without any creative efforts.

FIG. 1 illustrates a flowchart of an object detection method according to at least one embodiment of the present disclosure;

FIG. 2 illustrates a schematic diagram of detection boxes for a body object and a face object according to at least one embodiment of the present disclosure;

FIG. 3 illustrates a schematic diagram of an architecture of a network used in an object detection method according to at least one embodiment of the present disclosure;

FIG. 4 illustrates a schematic structural diagram of an object detection apparatus according to at least one embodiment of the present disclosure;

FIG. 5 illustrates a schematic structural diagram of an object detection apparatus according to at least one embodiment of the present disclosure.

### DETAILED DESCRIPTION

In order for those skilled in the art to better understand the technical solutions in one or more embodiments of the present disclosure, the technical solutions in one or more embodiments of the present disclosure will be clearly and completely described below in conjunction with the accompanying drawings in one or more embodiments of the present disclosure. Apparently, the described embodiments are merely a part of the embodiments of the present disclosure, rather than all of the embodiments. All other embodiments obtained by those ordinary skilled in the art based on one or more embodiments of the present disclosure without any creative efforts shall fall within the protection scope of the present disclosure.

When detecting targets in dense scenes, “false positive” may sometimes occur. For example, in a game place with relatively dense people, many people gather in the place to play games. Occlusions between people such as leg occlusion and arm occlusion may occur in images captured from the game place. Such occlusions between human bodies may lead to the occurrence of “false positive”. In order to improve the accuracy of target detection in the dense scenes, embodiments of the present disclosure provide an object detection method, which can be applied to detect individual human bodies in a crowded scene as target objects for detection.

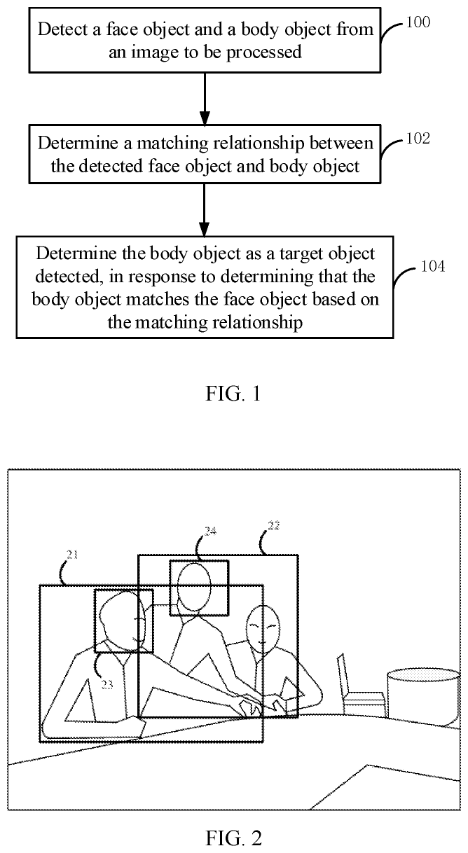

FIG. 1 illustrates a flowchart of an object detection method according to at least one embodiment of the present disclosure. As shown in FIG. 1, the method includes steps 100, 102 and 104.

At step 100, a face object and a body object are detected from an image to be processed.

The image to be processed may be an image of a dense scene, and a predetermined target object is expected to be detected from the image. In an example, the image to be processed may be an image of a multiplayer game scene, and the purpose of detection is to detect the number of people in the image to be processed, then each people in the image may be regarded as a target object to be detected.

In this step, each face object and body object included in the image to be processed may be detected. In an example, when detecting the face object and the body object from the image to be processed, object detection may be performed on the image to be processed to obtain detection boxes for the face object and the body object from the image. For example, feature extraction may be performed on the image to be processed to obtain image features, and then the object detection may be performed based on the image features to obtain the detection box for the face object and the detection box for the body object.

FIG. 2 schematically illustrates a plurality of detected detection boxes. As shown in FIG. 2, a detection box 21 includes a body object, and a detection box 22 includes another body object. A detection box 23 includes a face object, and a detection box 24 includes another face object.

At step 102, a matching relationship between the detected face object and body object is determined.

In this step, the detected face object may include at least one face object and the detected body object may include at least one body object. Based on each detected detection box obtained at step 100, each detected face object may be combined with each detected body object to obtain at least one face-and-body combination, and the matching relationship may be determined for each combination. For example, in the example of FIG. 2, the matching relationship between the detection box 21 and the detection box 23 may be detected, the matching relationship between the detection box 22 and the detection box 24 may be detected, the matching relationship between the detection box 21 and the detection box 24 may be detected, and the matching relationship between the detection box 22 and the detection box 23 may be detected.

The matching relationship represents whether the face object matches the body object. For example, a face object and a body object belonging to the same person may be determined to be a match. In an example, the body object included in the detection box 21 and the face object included in the detection box 23 belong to the same person in the image, and match each other. In contrast, the body object included in the detection box 21 and the face object included in the detection box 24 do not belong to the same person, and do not match each other.

In practical implementations, the above-mentioned matching relationship may be detected in various ways. In an exemplary embodiment, position information and/or visual information of the face object and the body object may be determined according to detection results for the face object and the body object; and the matching relationship between the face object and the body object may be determined according to the position information and/or the visual information.

The position information may indicate a spatial position of the face object and the body object in the image, or a spatial distribution relationship between the face object and the body object. The visual information may indicate visual feature information of each object in the image, which is generally an image feature, for example, image features of the face object and the body object in the image obtained by extracting visual features from the image.

In an example, for each face object, the detection box for the body object that satisfies a preset position overlapping relationship with the detection box for the face object may be determined as a target detection box, according to position information of the detection boxes for the detected body object and face object, and the body object in the target detection box may be determined as the body object that matches the face object. In an example, the position overlapping relationship may be preset as follows: the detection box for the face object overlaps with the detection box for the body object, and a ratio of an overlapping area to an area of the detection box for the face object reaches 90% or more. The detection box for each face object detected at step 100 may be combined in pairs with the detection box for each body object detected at step 100, and it is detected whether two detection boxes in a pair satisfy the above-mentioned preset overlapping relationship. If the two detection boxes satisfy the above-mentioned preset overlapping relationship, then it is determined that the face object and the body object respectively included in the two detection boxes match each other.

In another example, the matching relationship between the face object and the body object may also be determined according to the visual information of the face object and the body object. For example, the image features, that is, the visual information, of the detected face object and body object, may be obtained based on the face object and the body object, and the visual information of the face object and the body object may be combined to determine whether the face object matches the body object. In an example, a neural network may be trained to detect the matching relationship according to the visual information, and the trained neural network may be used to draw a conclusion as to whether the face object matches the body object according to the input visual information of the two.

In yet another example, the matching relationship between the face object and the body object may also be detected according to a combination of the position information and the visual information of the face object and the body object. In an example, the visual information of the face object and the body object may be used in combination with the position information of the two to determine whether the face object matches the body object. For example, the spatial distribution relationship between the face object and the body object, or the position overlapping relationship between the detection box for the face object and the detection box for the body object may be combined with the visual information to comprehensively determine whether the face object matches the body object by using a trained neural network. The trained neural network may include a visual information matching branch and a position information matching branch. The visual information matching branch is configured to match the visual information of the face object and the body object, the position information matching branch is configured to match the position information of the face object and the body object, and the matching results of the two branches may be combined to draw a conclusion whether the face object and the body object match each other. Alternatively, the trained neural network may adopt an “end-to-end” model to process the visual information and the position information of the face object, and the visual information and the position information of the body object to obtain the matching relationship between the face object and the body object.

At step 104, in response to determining that the body object matches the face object based on the matching relationship, the body object is determined as a target object detected.

In this step, based on the detection of the matching relationship at step 102, if a body object has a matching face object in the image, the body object may be determined as the detected target object. Otherwise, if a body object does not have a matching face object in the image, it may be determined that the body object is not the final detected target object.

In addition, based on the detection of the matching relationship between the face object and the body object, if it is determined that a body object does not have a matching face object based on the detected matching relationship, the detection box for the body object may be removed. For example, it is assumed that a detection box for a body object is detected from the image, the detection box is located in a preset edge area of the image which may be a predefined area within a certain range from an edge of the image, and there is no face object in the image matching the body object in the detection box, the body object in the detection box is not regarded as the detected target object. Optionally, this detection box located in the preset edge area of the image may be removed.

In other examples, if the body object has no matching face object due to the detection box for the body object being at the edge of the image, the body object in the detection box may also be determined as the target object. For example, in the case that it is determined based on the detection of the matching relationship that the body object in the detection box does not have a matching face object, it may be further determined whether the detection box is located in the preset edge area of the image. When it is determined that the detection box is located in the preset edge area, the body object may be determined as the detected target object though there is no face object in the image matching the body object. In practical implementations, whether to regard the body object in this case as the final detected target object may be flexibly determined according to actual business requirements. For example, in a people-counting sense, the body object in this case may be retained as the final detected target object.

In addition, before detecting the above-mentioned matching relationship, it may also be detected whether the face object is occluded by other face objects or any body object. In the case that the face object is not occluded by other face objects and any body object, an operation of determining the matching relationship between the face object and the detected body object may be performed. Otherwise, if a detected face object is occluded by other face objects, or the detected face object is occluded by any body object in the image, the face object may be deleted from the detection results. For example, in a scene of a multiplayer table game, due to a large number of people participating in the game, there may be situations where different people occlude each other, including body occlusion or even partial occlusion of the face. In this case, if a face is occluded by bodies or faces of other people, the detection accuracy of the face object may be reduced, and thus the detection accuracy of the body object may also be affected when the face object is used to assist in detection of the body object. However, as described above, in the case that it is determined that the face object is not occluded by other bodies or faces, the detection accuracy of the face object itself is relatively high, and thus use of the face object to assist in the detection of the body object may assist in improving the detection accuracy of the body object.

Furthermore, if it is detected that the detection box for the face object satisfies the preset position overlapping relationship with the detection box for the body object, and the face object is not occluded by other face objects and body objects, then it may be determined that the face object matches the body object. For example, with reference to FIG. 2, the body object in the detection box 21 satisfies the preset position overlapping relationship with the face object in the detection box 23, and the face object in the detection box 23 is not occluded by other face objects and body objects, then it is determined that the body object in the detection box 21 and the face object in the detection box 23 match each other, and the body object in the detection box 21 is the detected target object.

The object detection method according to the embodiments of the present disclosure assists in the detection of the body object by using the detection of the matching relationship between the body object and the face object, and uses the body object that has a matching face object as the detected target object. On one hand, since the detection accuracy of the face object is relatively high, the detection accuracy of the body object can also be improved by using the face object to assist in the detection of the body object; on the other hand, the face object belongs to the body object, thus the detection of the face object can assist in positioning the body object. This solution can reduce the occurrence of “false positive” or false detection, improving the detection accuracy of the target object.

In addition, in a crowded scene, a plurality of human bodies may be crossed or occluded each other. In a traditional human detection method, the crossed bodies of different people might be detected as the body object. The object detection method according to the present disclosure may match the detected body object with the face object, which can effectively filter out such a false-positive body object and provide a more accurate body object detection result.

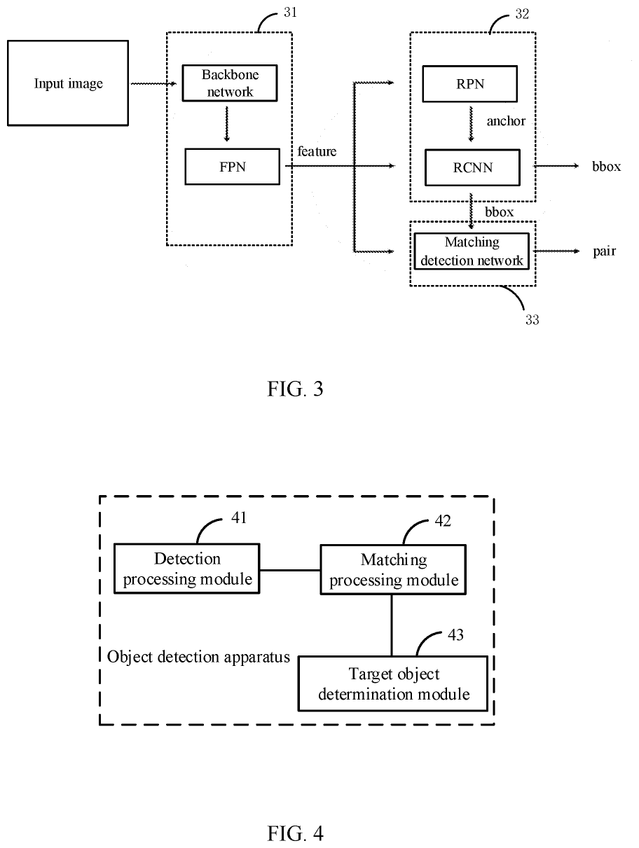

FIG. 3 illustrates a schematic diagram of an architecture of a network used in an object detection method according to at least one embodiment of the present disclosure. As shown in FIG. 3, the network used for target detection may include a feature extraction network 31, an object detection network 32, and a matching detection network 33.

The feature extraction network 31 is configured to perform feature extraction on the image to be processed (an input image in FIG. 3) to obtain a feature map of the image. In an example, the feature extraction network 31 may include a backbone network and a FPN (Feature Pyramid Network). The image to be processed may be processed through the backbone network and the FPN in turn, to extract the feature map.

For example, the backbone network may use VGGNet, ResNet, etc. The FPN may convert the feature map obtained from the backbone network into a feature map with a multi-layer pyramid structure. The backbone network, as a backbone part of the target detection network, is configured to extract the image features. The FPN, as a neck part of the target detection network, is configured to perform a feature enhancement processing, which may enhance shallow features extracted by the backbone network.

The object detection network 32 is configured to perform object detection based on the feature map of the image, to acquire at least one face box and at least one body box from the image to be processed. The face box is the detection box containing the face object, and the body box is the detection box containing the body object.

As shown in FIG. 3, the object detection network 32 may include an RPN (Region Proposal Network) and an RCNN (Region Convolutional Neural Network). The RPN may predict an anchor box (anchor) for each object based on the feature map output from the FPN, and the RCNN may predict a plurality of bounding boxes (bbox) based on the feature map output from the FPN and the anchor box, where the bounding box includes a body object or a face object. As mentioned above, the bounding box containing the body object is the body box, and the bounding box containing the face object is the face box.

The matching detection network 33 is configured to detect the matching relationship between the face object and the body object based on the feature map of the image, and the body object and the face object in the bounding boxes output from the RCNN.

The aforementioned object detection network 32 and matching detection network 33 may be equivalent to detectors in an object detection task, and configured to output the detection results. The detection results in the embodiments of the present disclosure may include a body object, a face object, and a matching pair. The matching pair is a pair of body object and face object that match each other.

It should be noted that the network structure of the aforementioned feature extraction network 31, object detection network 32, and matching detection network 33 is not limited in the embodiments of the present disclosure, and the structure shown in FIG. 3 is merely an example. For example, the FPN in FIG. 3 may not be used, but the feature map extracted by the backbone network may be directly used by the RPN/RCNN or the like to make a prediction for the position of the object. For another example, FIG. 3 illustrates a framework of a two-stage target detection network, which is configured to perform object detection by using the feature extraction network and the object detection network. In practical implementations, a one-stage target detection network may also be used, and in this case, there is no need to provide an independent feature extraction network, and the one-stage target detection network may be used as the object detection network in this embodiment to achieve feature extraction and object detection. When the one-stage target detection network is used, a body object and a face object, after obtained, may then be used to predict a matching pair.

For the network structure shown in FIG. 3, the network may be trained firstly, and then the trained network may be used to detect a target object in the image to be processed. The training and application process of the network will be described below.

Sample images may be used for network training. For example, a sample image set may be acquired, and each sample image in the sample image set may be input to the feature extraction network 31 shown in FIG. 3 to obtain the extracted feature map of the image. Then, the object detection network 32 detects and acquires at least one face box and at least one body box from the sample image according to the feature map of the image. Then, the matching detection network 33 acquires the pairwise matching relationship between the detected face box and body box. For example, any face box may be combined with any body box to form a face-and-body combination, and it is detected whether the face object and the body object in the combination match each other. A detection result for the matching relationship may be referred to as a predicted value of the matching relationship, and a true value of the matching relationship may be referred to as a label value of the matching relationship. Finally, a network parameter of at least one of the feature extraction network, the object detection network, and the matching detection network may be adjusted according to a difference between the label value and the predicted value of the matching relationship. The network training may be ended until a predetermined network training end condition is satisfied, and the trained network structure shown in FIG. 3 for target detection may be obtained.

After the network training is completed, for example, if the number of human bodies needs to be detected from a certain image to be processed, where different people occlude each other, then the image to be processed may be processed according to the network architecture shown in FIG. 3. The trained feature extraction network 31 may firstly extract a feature map of the image, and then the trained object detection network 32 may acquire a face box and a body box from the image, and the trained matching detection network 33 may detect the matching face object and body object to obtain a matching pair. Then, the body object that has not successfully matched the face object may be removed, and is not regarded as the detected target object. If the body object does not have a matching face object, it may be considered that the body object is a “false positive” body object. In this way, the detection results of the body objects may be filtered by using the detection results of the face objects with a higher accuracy, which can improve the detection accuracy of the body object, and reduce the false detection caused by occlusions between the body objects especially in multi-person scenes.

The object detection method according to the embodiments of the present disclosure assists in the detection of the body object by using the detection of the face object with a high accuracy, and an correlation relationship between the face object and the body object, such that the detection accuracy of the body object may be improved, and the false detection caused by occlusions between objects may be solved.

In some embodiments, the detection result for the target object in the image to be processed may be saved. For example, in a multiplayer game, the detection result may be saved in a cache for the multiplayer game, so as to analyse a game status, changes in players, etc. according to the cached information. Alternatively, the detection result for the target object in the image to be processed may be visually displayed, for example, the detection box of the detected target object may be drawn and shown in the image to be processed.

In order to implement the object detection method of any of the embodiments of the present disclosure, FIG. 4 illustrates a schematic structural diagram of an object detection apparatus according to at least one embodiment of the present disclosure. As shown in FIG. 4, the apparatus includes a detection processing module 41, a matching processing module 42 and a target object determination module 43.

The detection processing module 41 is configured to detect a face object and a body object from an image to be processed.

The matching processing module 42 is configured to determine a matching relationship between the detected face object and body object.

The target object determination module 43 is configured to, in response to determining that the body object matches the face object based on the matching relationship, determine the body object as a target object detected.

In an example, the detection processing module 41 may be further configured to perform object detection on the image to be processed to obtain detection boxes for the face object and the body object from the image.

In an example, the target object determination module 43 may be further configured to remove the detection box for the body object, in response to determining that there is no face object in the image matching the body object based on the matching relationship.

In an example, the target object determination module 43 may be further configured to determine the body object as the detected target object, in response to determining that there is no face object in the image matching the body object based on the matching relationship, and the body object being located in a preset edge area of the image.

In an example, the matching processing module 42 may be further configured to determine position information and/or visual information of the face object and the body object according to detection results for the face object and the body object; and determine the matching relationship between the face object and the body object according to the position information and/or the visual information.

In an example, the position information may include position information of the detection boxes. The matching processing module 42 may be further configured to: for each face object, determine the detection box for the body object that satisfies a preset position overlapping relationship with the detection box for the face object as a target detection box, according to the position information of the detection boxes, and determine the body object in the target detection box as the body object that matches the face object.

In an example, the matching processing module 42 may be further configured to determine the matching relationship between the detected face object and body object, in response to the detected face object being not occluded by the detected body object and other face objects.

In an example, the detected face object may include at least one face object and the detected body object may include at least one body object. The matching processing module 42 may be further configured to combine each of the detected face object with each of the detected body object to obtain at least one face-and-body combination, and determine the matching relationship for each of the combination.

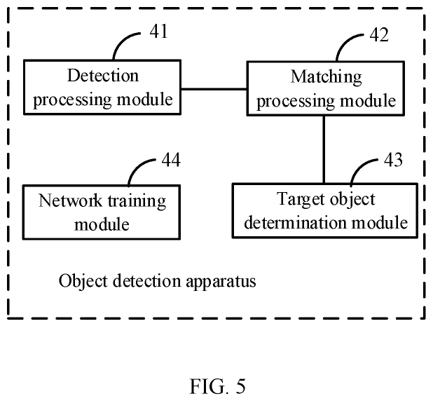

In an example, as shown in FIG. 5, the apparatus may further include a network training module 44.

The detection processing module 41 may be further configured to perform the object detection on the image to be processed using an object detection network to obtain the detection boxes for the face object and the body object from the image.

The matching processing module 42 may be further configured to determine the matching relationship between the detected face object and body object using a matching detection network.

The network training module 44 may be configured to detect at least one face box and at least one body box from a sample image through the object detection network to be trained; acquire a predicted value of a pairwise matching relationship between the detected face box and body box through the matching detection network to be trained; and adjust a network parameter of at least one of the object detection network and the matching detection network, based on a difference between the predicted value and a label value of the matching relationship.

The object detection apparatus according to the embodiments of the present disclosure assists in the detection of the body object by using the detection of the matching relationship between the body object and the face object, and uses the body object that has a matching face object as the detected target object, making the detection accuracy of the body object higher.

The present disclosure also provides an electronic device including a memory and a processor, the memory is configured to store computer instructions executable on the processor, and the processor is configured to perform the method of any of the embodiments of the present disclosure when executing the computer instructions.

The present disclosure also provides a computer-readable storage medium in which a computer program is stored, the computer program, when executed by a processor, causes the processor to perform the method of any of the embodiments of the present disclosure.

The present disclosure further provides a computer program, including computer-readable codes which, when executed in an electronic device, cause a processor in the electronic device to perform the method of any of the embodiments of the present disclosure.

Those skilled in the art should understand that one or more embodiments of the present disclosure may be provided as a method, a system, or a computer program product. Therefore, one or more embodiments of the present disclosure may adopt the form of a complete hardware embodiment, a complete software embodiment, or an embodiment combining software and hardware. Moreover, one or more embodiments of the present disclosure may adopt the form of a computer program product implemented on one or more computer-usable storage media (including but not limited to disk storage, CD-ROM, optical storage, etc.) containing computer-usable program codes.

As used herein, “and/or” means having at least one of the two, for example, “A and/or B” includes three schemes: A, B, and “A and B”.

The various embodiments in the present disclosure are described in a progressive manner, and the same or similar parts between the various embodiments may be referred to each other. Each embodiment focuses on the differences from other embodiments. In particular, as for the data processing device embodiment, since it is basically similar to the method embodiment, the description thereof is relatively simple, and reference may be made to the partial description of the method embodiment for the related parts.

The foregoing describes specific embodiments of the present disclosure. Other embodiments are within the scope of the appended claims. In some cases, the actions or steps recited in the claims may be performed in a different order than in the embodiments and may still achieve desired results. In addition, the processes depicted in the drawings do not necessarily require the specific order or sequential order shown in order to achieve the desired results. In some embodiments, multitasking and parallel processing are also possible or may be advantageous.

The embodiments of the subject matter and functional operations described in this disclosure may be implemented in: digital electronic circuits, tangibly embodied computer software or firmware, computer hardware including the structures disclosed in this disclosure and structural equivalents thereof, or a combination of one or more of them. Embodiments of the subject matter described in the present disclosure may be implemented as one or more computer programs, that is, one or more modules of the computer program instructions encoded on a tangible non-transitory program carrier to be executed by a data processing device or to control the operation of the data processing device. Alternatively or additionally, the program instructions may be encoded on artificially generated propagated signals, such as machine-generated electrical, optical or electromagnetic signals, which are generated to encode information and transmit it to a suitable receiver device for execution by the data processing device. The computer storage medium may be a machine-readable storage device, a machine-readable storage substrate, a random or serial access memory device, or a combination of one or more of them.

The processing and logic flows described in the present disclosure may be executed by one or more programmable computers executing one or more computer programs to perform corresponding functions by operating according to input data and generating output. The processing and logic flows may also be executed by a dedicated logic circuit, such as FPGA (Field Programmable Gate Array) or ASIC (Application Specific Integrated Circuit), and the device may also be implemented as the dedicated logic circuit.

Computers suitable for executing computer programs include, for example, general-purpose and/or special-purpose microprocessors, or any other type of central processing unit. Generally, the central processing unit will receive instructions and data from a read-only memory and/or a random access memory. The basic components of a computer include a central processing unit for implementing or executing instructions and one or more memory devices for storing instructions and data. Generally, the computer will also include one or more mass storage devices for storing data, such as magnetic disks, magneto-optical disks, or optical disks, or the computer will be operatively coupled to the mass storage device to receive data from or transmit data to it, or both. However, the computer does not have to have such a device. In addition, the computer may be embedded in another device, such as a mobile phone, a personal digital assistant (PDA), a mobile audio or video player, a game console, a global positioning system (GPS) receiver, or a portable storage device such as a universal serial bus (USB) and a flash drive, for example.

Computer-readable media suitable for storing computer program instructions and data include all forms of non-volatile memory, media and memory device, including, for example, semiconductor memory devices (such as EPROMs, EEPROMs, and flash memory devices), magnetic disks (such as internal Hard disks or removable disks), magneto-optical disk and CD ROM and DVD-ROM disk. The processor and the memory may be supplemented by or incorporated into a dedicated logic circuit.

Although the present disclosure contains many specific implementation details, these should not be construed as limiting the scope of any disclosure or the scope of protection, but are mainly used to describe the features of detailed embodiments of the specific disclosure. Certain features described in multiple embodiments within the present disclosure may also be implemented in combination in a single embodiment. On the other hand, various features described in a single embodiment may also be implemented in multiple embodiments separately or in any suitable sub-combination. In addition, although features may function in certain combinations as described above and even initially claimed as such, one or more features from the claimed combination may in some cases be removed from the combination, and the claimed combination may be directed to a sub-combination or a variant of the sub-combination.

Similarly, although operations are depicted in a specific order in the drawings, this should not be understood as requiring these operations to be performed in the specific order shown or sequentially, or requiring all illustrated operations to be performed, to achieve the desired result. In some cases, multitasking and parallel processing may be advantageous. In addition, the separation of various system modules and components in the above embodiments should not be understood as requiring such separation in all embodiments, and it should be understood that the described program components and systems may usually be integrated together in a single software product, or packaged into multiple software products.

The above descriptions are only some embodiments of one or more embodiments of the present disclosure, and are not intended to limit one or more embodiments of the present disclosure. Any modification, equivalent replacement, improvement, etc. made within the spirit and principle of one or more embodiments of the present disclosure shall be included within the protection scope of one or more embodiments of the present disclosure.

1. An object detection method, comprising:
detecting one or more face objects and one or more body objects from an image to be processed;
determining a matching relationship between a face object of the one or more face objects and a body object of the one or more body objects; and
in response to determining that the body object matches the face object based on the matching relationship, determining the body object as a detected target object.

2. The method of claim 1, wherein detecting the one or more face objects and the one or more body objects from the image to be processed comprises:
performing object detection on the image to obtain detection boxes for the one or more face objects and the one or more body objects from the image.

3. The method of claim 2, further comprising:
in response to determining that there is no face object in the image matching a particular body object in a particular detection box, removing the particular detection box for the particular body object.

4. The method of claim 1, further comprising:
in response to determining that there is no face object in the image matching a second body object and that the second body object is located in a preset edge area of the image, determining the second body object as a second detected target object.

5. The method of claim 1, wherein determining the matching relationship between the face object and the body object comprises:
determining at least one of position information or visual information of the face object and the body object according to detection results for the face object and the body object; and
determining the matching relationship between the face object and the body object according to the at least one of the position information or the visual information.

6. The method of claim 1, comprising:
determining position information of detection boxes for the one or more face objects and the one or more body objects; and
for each of the one or more face objects,
determining a detection box for a particular body object that satisfies a preset position overlapping relationship with a detection box for the face object as a target detection box, according to the position information of the detection boxes; and
determining the particular body object in the target detection box as a target body object that matches the face object.

7. The method of claim 1, wherein determining the matching relationship between the face object and the body object comprises:
in response to determining that the face object is not occluded by the body object and other face objects, determining the matching relationship between the face object and the body object.

8. The method of claim 1, comprising:
combining each of the one or more face objects with each of the one or more body objects to obtain one or more face-and-body combinations, and
determining a respective matching relationship for each of the one or more face-and-body combinations.

9. The method of claim 1, wherein detecting the one or more face objects and the one or more body objects from the image to be processed comprises:
performing object detection on the image using an object detection network to obtain detection boxes for the one or more face objects and the one or more body objects from the image,
wherein determining the matching relationship between the face object and the body object comprises:
determining the matching relationship between the face object and the body object using a matching detection network, and
wherein the object detection network and the matching detection network are trained by:
detecting at least one face box and at least one body box from a sample image through the object detection network to be trained,
acquiring a predicted value of a pairwise matching relationship between the at least one face box and the at least one body box through the matching detection network to be trained, and
adjusting a network parameter of at least one of the object detection network and the matching detection network based on a difference between the predicted value and a label value of the pairwise matching relationship.

10. An electronic device, comprising:
at least one processor; and
one or more memories coupled to the at least one processor and storing programming instructions for execution by the at least one processor to perform operations comprising:
detecting one or more face objects and one or more body objects from an image to be processed;
determining a matching relationship between a face object of the one or more face objects and a body object of the one or more body objects; and
in response to determining that the body object matches the face object based on the matching relationship, determining the body object as a detected target object.

11. The electronic device of claim 10, wherein detecting the one or more face objects and the one or more body objects from the image to be processed comprises:
performing object detection on the image to obtain detection boxes for the one or more face objects and the one or more body objects from the image.

12. The electronic device of claim 11, wherein the operations further comprise:
in response to determining that there is no face object in the image matching a particular body object in a particular detection box, removing the particular detection box for the particular body object.

13. The electronic device of claim 10, wherein the operations further comprise:
in response to determining that there is no face object in the image matching a second body object and that the second body object is located in a preset edge area of the image, determining the second body object as a second detected target object.

14. The electronic device of claim 10, wherein determining the matching relationship between the face object and the body object comprises:
determining at least one of position information or visual information of the face object and the body object according to detection results for the face object and the body object; and
determining the matching relationship between the face object and the body object according to the at least one of the position information or the visual information.

15. The electronic device of claim 10, wherein the operations comprise:
determining position information of detection boxes for the one or more face objects and the one or more body objects;
for each of the one or more face objects,
determining a detection box for a particular body object that satisfies a preset position overlapping relationship with a detection box for the face object as a target detection box, according to the position information of the detection boxes; and
determining the particular body object in the target detection box as a target body object that matches the face object.

16. The electronic device of claim 10, wherein determining the matching relationship between the face object and the body object comprises:
in response to determining that the face object is not occluded by the body object and other face objects, determining the matching relationship between the face object and the body object.

17. The electronic device of claim 10, wherein the operations comprise:
combining each of the one or more face objects with each of the one or more body objects to obtain one or more face-and-body combinations, and
determining a respective matching relationship for each of the one or more face-and-body combinations.

18. The electronic device of claim 10, wherein detecting the one or more face objects and the one or more body objects from the image to be processed comprises:
performing object detection on the image using an object detection network to obtain detection boxes for the one or more face objects and the one or more body objects from the image,
wherein determining the matching relationship between the face object and the body object comprises:
determining the matching relationship between the face object and the body object using a matching detection network, and
wherein the object detection network and the matching detection network are trained by:
detecting at least one face box and at least one body box from a sample image through the object detection network to be trained,
acquiring a predicted value of a pairwise matching relationship between the at least one face box and the at least one body box through the matching detection network to be trained, and
adjusting a network parameter of at least one of the object detection network and the matching detection network based on a difference between the predicted value and a label value of the pairwise matching relationship.

19. A non-transitory computer-readable storage medium coupled to at least one processor and storing programming instructions for execution by the at least one processor to perform operations comprising:
detecting one or more face objects and one or more body objects from an image to be processed;
determining a matching relationship between a face object of the one or more face objects and a body object of the one or more body objects; and
in response to determining that the body object matches the face object based on the matching relationship, determine the body object as a detected target object.

20. The non-transitory computer-readable storage medium of claim 19, wherein detecting the one or more face objects and the one or more body objects from the image to be processed comprises:
performing object detection on the image to obtain detection boxes for the one or more face objects and the one or more body objects from the image; and
wherein the operations further comprise:
in response to determining that there is no face object in the image matching a particular body object in a particular detection box, removing the particular detection box for the particular body object.
